(19) United States
(12) Patent Application Publication
(10) Pub. No.: US 2008/0044058 A1
(43) Pub. Date: Feb. 21, 2008

(54) SYSTEM AND METHOD FOR SETTING IMAGE-MONITORING REGIONS

(75) Inventors: Chaucer Chiu, Taipei (TW); Mike Pan, Taipei (TW); Xin-Jun Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/672,186

(22) Filed: Feb. 7, 2007

(30) Foreign Application Priority Data
Aug. 17, 2006 (TW) 095130209

(51) Int. Cl. G06K 9/00

(52) U.S. Cl. 382/103

(57) ABSTRACT

This invention provides a system and method for setting image-monitoring regions for installing in an image-monitoring system to assist users in setting image-monitoring regions for the image-monitoring system to execute image-monitoring operations accordingly, the method including the steps of: dividing image data outputted by the image-monitoring system into a plurality of unit image regions; selecting unit image regions that need to be monitored according to the image data contained in each of the unit image regions; and having the image-monitoring system to execute a corresponding monitoring operation on the selected unit image regions, thereby making the setting operation of image-monitoring regions more direct and accurate for users' easy operation.

### BACKGROUND OF THE INVENTION

1. Field of the Invention

This invention relates to a technology for setting image-monitoring regions, and more particularly, to a system and method for easily setting image-monitoring regions for users.

2. Description of Related Art

The development of video monitoring systems has been generally through three stages. In early 1990's, there are CCTV monitoring systems mainly based on analogical equipments, which are called the first generation of analogical monitoring systems. In the middle of age nineteen, according as the processing capability of computers is increasing and video technology is developed, people can collect and process the video signals by high speed processing of computers, and achieve the multi-screen display of the images by means of the high resolution on monitors, thereby making the quality of the images increasing. The video monitoring system based on PC as a console system of multimedia is called the second generation of digitalized local video monitoring system. In the end of 20th century, according as network bandwidth, the processing capability of computers and storage capacity are further increasing and as various practical technologies of video processing appear, video monitoring is approaching into a fully digitalized network time, which means the time of the third generation of remote video monitoring system. The third generation of video monitoring system is based on internet, the key of compression/storage/play in digital video and the feature of intelligent image analysis, causing the technological revolution of video monitoring, and being put upon high emphasis by the academy and the industry.

Owing to the broadly perspective development of digital video monitoring system, a mobile detection technology in digital video monitoring system has been developed so as to increase performance and reduce the load of manual operations. By means of the detection technology, users can firstly set the regions that need to execute mobile detection in monitoring screens. When users activate a video monitoring system, an alarm message is outputted according to the alarm mode set by users in advance if the video monitoring system detects anomaly situation (e.g. appearing mobile objects at warehouse entrance) in the mobile regions. For example, a short message is sent to the address assigned by users via internet or short message center, and current image is sent to the users by emails, thereby effectively preventing from various disadvantage caused by the long-time manual monitoring in video monitoring operations.

Yet, when users need to select mobile detection regions by mobile detection technology, normally a way of drawing a frame round by a cursor (mouse cursor) is selected, which way is limited by its accuracy and the mobile detection regions where are set have regular shapes, e.g. rectangle, ellipse and the like. Further, when users intend to cancel part of the selected regions, it is used to reselect mobile detection regions instead of canceling part of the selected regions, that makes users hard to observe the modification directly for mobile detection regions.

Accordingly, how to solve the disadvantage from setting mobile detection regions as described above is a technological issue to be solved by the industry.

### SUMMARY OF THE INVENTION

Owing to the disadvantage of the prior art described above, the main objective of the present invention is to provide a system and method for setting image-monitoring regions, thereby making the operation of setting image-monitoring regions more easy to see directly.

Another objective of the invention is to provide a system and method for setting image-monitoring regions, thereby making the modification and cancellation for setting video monitoring operation very convenient and fast.

Further objective of the invention is to provide a system and method for setting image-monitoring regions, thereby increasing the accuracy for setting video monitoring operation.

In order to achieve the objective described above and other objectives, the present invention provides a system and method for setting image-monitoring regions. This invention provides a method for setting image-monitoring regions for installing in an image-monitoring system to assist users in setting image-monitoring regions for the image-monitoring system to execute image-monitoring operation accordingly, which method includes the steps of: dividing image data outputted by the image-monitoring system into a plurality of unit image regions, selecting unit image regions that need to be monitored according to the image data contained in each of the unit image regions, and executing a corresponding monitoring operation by the image-monitoring system on the selected unit image regions.

Wherein the step of dividing image data further includes forming a grating on the image data outputted by the image-monitoring system so as to divide the image data into a plurality of unit image regions, the method further includes that the image-monitoring system detects the selected unit image regions, and actuates a detection recording operation after detecting the unit image regions and determining that objects in the selected unit image regions are moving. The image-monitoring system detects the selected unit image regions, and stops executing a detection recording operation after determining that no objects in the selected unit image regions are moving.

The system for setting image-monitoring regions of this invention includes a dividing module which regionally divides the image data outputted by the image-monitoring system into a plurality of unit image regions, a setting module which selects unit image regions that need to be monitored according to the image data contained in each of the unit image regions, and a processing module which executes a corresponding monitoring operation by the image-monitoring system in the selected unit image regions.

Wherein the dividing module is to form a grating on the image data outputted by the image-monitoring system so as to divide the image data into a plurality of unit image regions, the processing module further includes that the image-monitoring system detects the selected unit image regions, and actuates a detection recording operation after detecting the unit image regions and determining that objects in the selected unit image regions are moving. The image-monitoring system detects the selected unit image regions, and stops executing a detection recording operation after determining that no objects in the selected unit image regions are moving.

In summary as described above, this invention provides a system and method for setting image-monitoring regions, dividing image data outputted by the image-monitoring system into a plurality of unit image regions and selecting unit image regions that need to be monitored according to the image data contained in each of the unit image regions, thereby making the setting operation of image-monitoring regions simple, direct and easy to operate.

### BRIEF DESCRIPTION OF DRAWINGS

FIG. 1 is a flowchart illustrating a basic framework of the system for setting image-monitoring regions of the invention;

FIG. 2 is a flowchart illustrating a operation flow of the method for setting image-monitoring regions of the invention; and

FIG. 3 is an exemplary schematic diagram of implementation application showing a system and method for setting image-monitoring regions of the invention.

### DETAILED DESCRIPTION OF PREFERRED EMBODIMENTS

The invention has been described below using particular specific embodiments for those skilled in the art to easily have the benefit and effect of the contents disclosed herein. The invention can be implemented or applied by other different specific embodiments. Many modifications and variations may be made without departing from the spirit of the invention based on the various detail of the invention from different viewpoint and application.

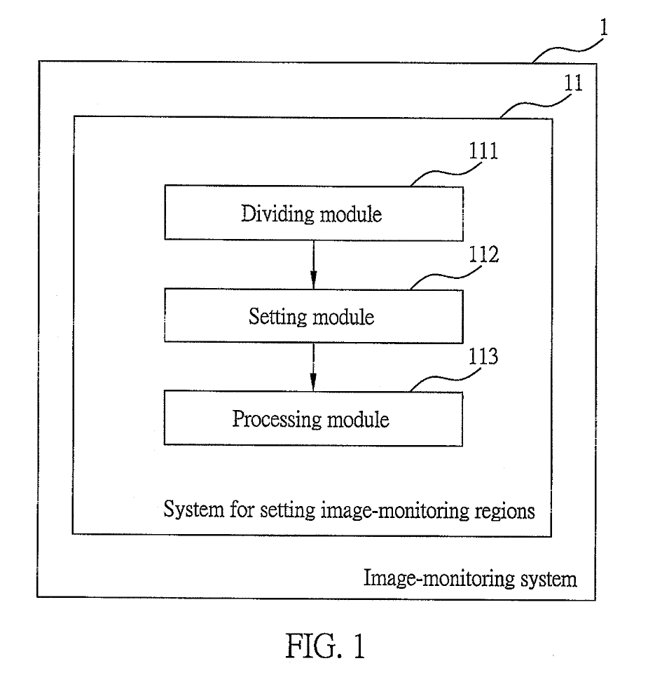

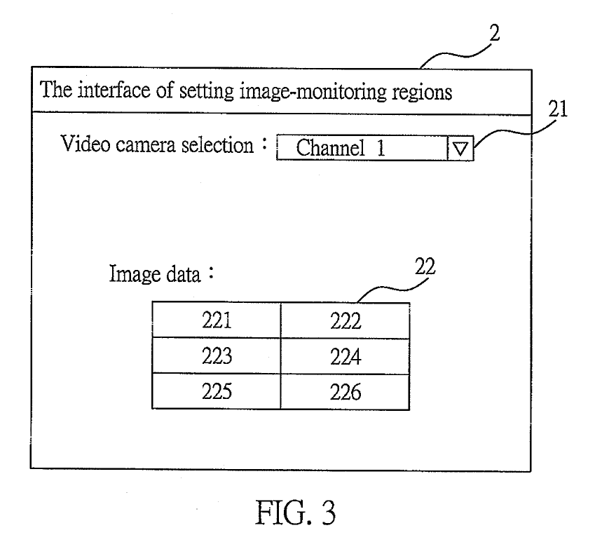

Turning now to FIG. 1 and FIG. 3, with a basic framework a schematic diagram of a system for setting image-monitoring regions 11 of the invention is illustrated. The system for setting image-monitoring regions 11 provides for installing in an image-monitoring system 1 to assist users in setting image-monitoring regions for the image-monitoring system 1 to execute image-monitoring operation accordingly. In the embodiment of the invention, the image-monitoring system 1 is a digital monitoring system.

As illustrated in FIG. 1, the system for setting image-monitoring regions 11 of the invention includes a dividing module 111, a setting module 112 and a processing module 113, as discussed in great details below.

The dividing module 111 provides for dividing image data outputted by the image-monitoring system 1 into a plurality of unit image regions, in the embodiment of the invention, forming a grating on the image data outputted by the image-monitoring system 1 into a plurality of unit image regions, as illustrated in FIG. 3. In the interface of setting image-monitoring regions 2, the dividing module 111 forms 2*3 gratings on the image data 22 by dividing the image data 22 into the unit image regions 221, unit image regions 222, unit image regions 223, unit image regions 224, unit image regions 225 and unit image regions 226. It should be noted that, if the image-monitoring system 1 is set by many video cameras corresponding video camera (e.g. Channel 1) is selected from the video camera selection field 21 in order to acquire corresponding image data.

The setting module 112 provides for selecting unit image regions that need to be monitored according to the image data contained in each of the unit image regions: unit image regions 221, unit image regions 222, unit image regions 223, unit image regions 224, unit image regions 225 and unit image regions 226, which are divided by the dividing module 111. Suppose the image data contained in the unit image regions 222 is a door of warehouse, a supervisor who monitors can select a click to the unit image regions 222 to be the regions that need to be monitored in order to see if there is anyone who breaks into the warehouse. If the supervisor who monitors selects a wrong click to the unit image regions 223 to be the regions that need to be monitored, the setting can be cancelled by selecting the click to the unit image regions 223 again.

The processing module 113 provides for executing a corresponding monitoring operation on the selected unit image regions selected by the setting module 112 in the image-monitoring system 1. In the embodiment of the invention, the image-monitoring system 1 executes mobile detection operation in the unit image regions 222 selected by the setting module 112. The image-monitoring system 1 detects the selected unit image regions 222, and actuates a detection recording operation after the processing module 113 detects the unit image regions 222 and determines that objects in the selected unit image regions 222 are moving. The image-monitoring system 1 detects the selected unit image regions 222, and stops executing a detection recording operation after determining that no objects in the selected unit image regions are moving. Besides, the processing module 113 can send a short message via internet or via a short message center to the address assigned in advance by the supervisor who monitors, after detecting the unit image regions 122 and determining that objects in the selected unit image regions 122 are moving, and send the live image messages, e.g. by the way of email communication and the like, to the supervisors who monitor as alarm messages.

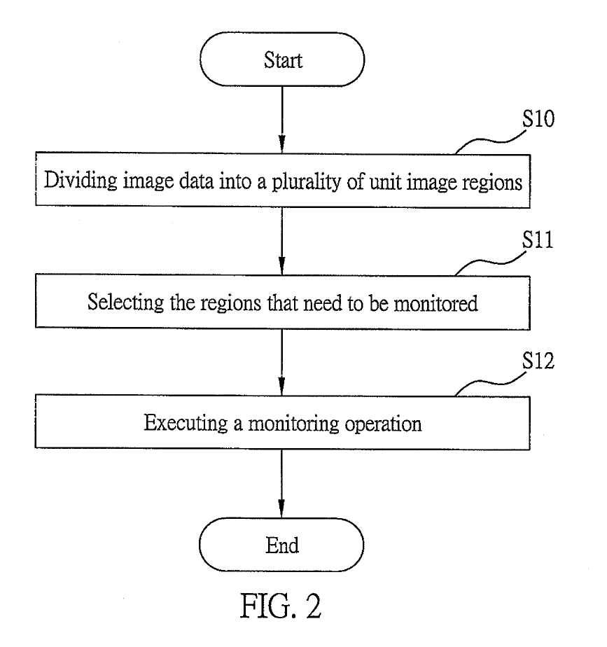

Turning now to FIG. 2, a schematic operation situation of the method for setting image-monitoring regions of the invention is illustrated. Firstly step S10 is executed, the dividing module 111 divides the image data outputted by the image-monitoring system 1 into a plurality of unit image regions. In the embodiment of the invention, the dividing module 111 is to form a grating on the image data 22 outputted by the image-monitoring system 1 so as to divide the image data into the unit image regions 221, unit image regions 222, unit image regions 223, unit image regions 224, unit image regions 225 and unit image regions 226 (as shown in FIG. 3). Next step S11 is executed.

In the step S11, the setting module 112 selects the unit image regions that need to be monitored according to the image data contained in each of the unit image regions: unit image regions 221, unit image regions 222, unit image regions 223, unit image regions 224, unit image regions 225 and unit image regions 226. For example, the image data contained in the unit image regions 222 is a door of warehouse, users can select a click to the unit image regions 222 to be the regions that need to be monitored in order to see if there is anyone who breaks into the warehouse. Next step S12 is executed.

In the step S12, the processing module 113 executes a corresponding monitoring operation on the selected unit image regions selected by the setting module 112 in the image-monitoring system 1. In the embodiment of the invention, the image-monitoring system 1 executes mobile detection operation in the unit image regions 222 selected by the setting module 112. The image-monitoring system 1 detects the selected unit image regions 222, and actuates a detection recording operation after the processing module 113 detects the unit image regions 222 and determines that objects in the selected unit image regions 222 are moving. The image-monitoring system 1 detects the selected unit image regions 222, and stops executing a detection recording operation after determining that no objects in the selected unit image regions are moving. Besides, the processing module 113 can send a short message via internet or via a short message center to the address assigned in advance by the supervisor who monitors after detecting the unit image regions 122 and determining that objects in the selected unit image regions 122 are moving, and send the live image messages by emails to the user, thereby alerting the supervisor who monitors.

It should be noted that, as judged by the processing module 113 the judgment whether the objects in the unit image regions 222 are moving or not is in accordance with the algorithm installed in advance, such that is the conventional skill in the art and therefore not mentioned more than what is needed herein.

In summary as described above, the system and method for setting image-monitoring regions of the invention are to regionally divide image data outputted by the image-monitoring system into a plurality of unit image regions, thereby corresponding selecting operation is executed by users according to the image data contained in each of the unit image regions. As compared with a conventional way of drawing a frame round by a cursor, the method for setting image-monitoring regions of the invention is more direct and easy to operate, that is further beneficial to users to modify or cancel at their choices as setting monitoring regions, and hence making the interface of setting monitoring-regions more compatible with humanistic requirement of operation.

The principle and effect of the invention has been described using exemplary embodiments above. However, it is to be understood that the scope of the invention is not limited to the disclosed embodiments. Many modifications and variations may be made by one of ordinary skill in the art without departing from the spirit and scope of the embodiments above. Accordingly, the scope of the claims, therefore, should be accorded the broadest interpretation so as to encompass all such modifications and similar arrangements.

What is claimed is:

1. A method for setting image-monitoring regions for installing in an image-monitoring system to assist users in setting image-monitoring regions for the image-monitoring system to execute image-monitoring operations accordingly,
the method for setting image-monitoring regions comprising:
dividing image data outputted by the image-monitoring system into a plurality of unit image regions;
selecting unit image regions that need to be monitored according to the image data contained in each of the unit image regions; and
executing a corresponding monitoring operation by the image-monitoring system on the selected unit image regions.

2. The method for setting image-monitoring regions as recited in claim 1, wherein the step of dividing image data further comprises forming a grating on the image data outputted by the image-monitoring system, so as to divide the image data into the unit image regions.

3. The method for setting image-monitoring regions as recited in claim 1 further comprising having the image-monitoring system to detect the selected unit image regions, and actuate a detection recording operation after determining that objects in the selected unit image regions are moving.

4. The method for setting image-monitoring regions as recited in claim 1 further comprising having the image-monitoring system to detect the selected unit image regions, and stops executing a detection recording operation after determining that no objects in the selected unit image regions are moving.

5. A system for setting image-monitoring regions for installing in an image-monitoring system to assist users in setting image-monitoring regions for the image-monitoring system to execute image-monitoring operations accordingly,
the system for setting image-monitoring regions comprising:
a dividing module, which regionally divides image data outputted by the image-monitoring system into a plurality of unit image regions;
a setting module, which selects unit image regions that need to be monitored according to the image data contained in each of the unit image regions; and
a processing module, which executes a corresponding monitoring operation by the image-monitoring system in the selected unit image regions.

6. The system for setting image-monitoring regions as recited in claim 5, wherein the dividing module is to form a grating on the image data outputted by the image-monitoring system, so as to divide the image data into the unit image regions.

7. The system for setting image-monitoring regions as recited in claim 5, wherein the processing module further detects the unit image regions selected by the setting module, and enables the image-monitoring system to actuate a detection recording operation after determining objects in the selected unit image regions are moving.

8. The system for setting image-monitoring regions as recited in claim 5, wherein the processing module further detects the unit image regions selected by the setting module, and enables the image-monitoring system to stop executing a detection recording operation after determining that no objects in the selected unit image regions are moving.
